(19) United States
(12) Patent Application Publication
(10) Pub. No.: US 2015/0175189 A1
(43) Pub. Date: Jun. 25, 2015

(54) SWING SYSTEM FOR STROLLER'S/BUGGY 'S AND PRAM'S

(71) Applicant: Fateha Khanam Chowdhury, Ilford (GB)

(72) Inventor: Fateha Khanam Chowdhury, Ilford (GB)

(21) Appl. No.: 13/670,478

(22) Filed: Nov. 7, 2012

(51) Int. Cl. B62B 9/22; B62B 7/14

(52) U.S. Cl. CPC B62B 9/22; B62B 7/145

(57) ABSTRACT

This invention relates to a new and innovative release system for stroller seats placed on either sides of the seat shown on drawing 1 FIG. 4 so to let the seat swing gently forward and back to provide an entertainment to the child on stroller journeys. The release frame which acts to pivot the swing system is safely placed away from the child's arm's reach. There is a manually operated lever which is located on the handle to also act as the main response to release the swing system of the seat can be detached and the release frame can also be taken out as shown on drawing 2 FIG. 2.

This invention relates to a swing system for strollers/buggys and prams. The swing system would appear to be in the same principle as the ones which are found in amusement and adventure playgrounds or adventure parks, with the added benefit of it being incorporated within prams, buggys and strollers. The scat is capable of moving forward and back gently, as oppose to a rocker which does not have the full capability of the swinging motion to travel to at least 100 degrees forward and back, giving the child entertainment when seated on a stroller.

Nowadays, strollers, buggys and prams alike, lack an entertainment feature which could soothe infants to sleep, lulling the baby on their journey, on long days out, or when the parent(s) take(s) the child out shopping, children often become impatient and toys placed in front of the child does not entertain the child in a way this swing system for a stroller could, FIG. 4.

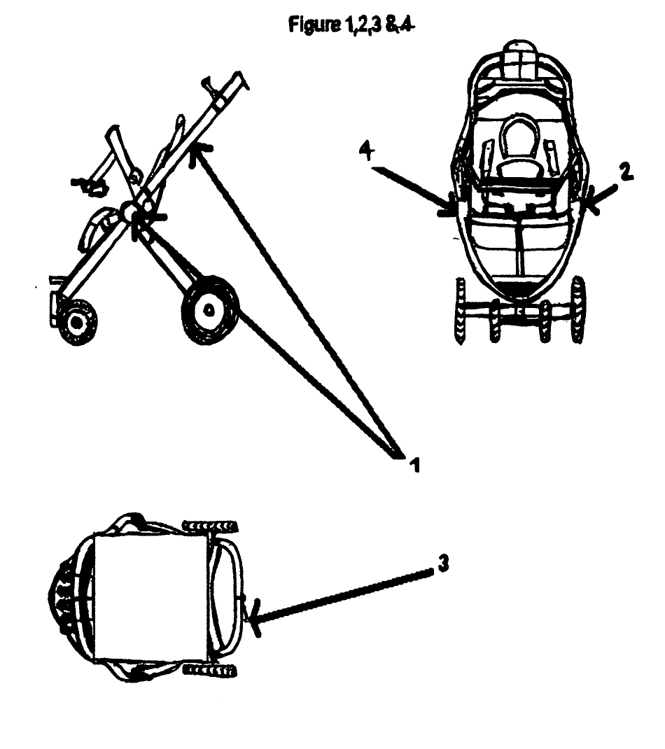

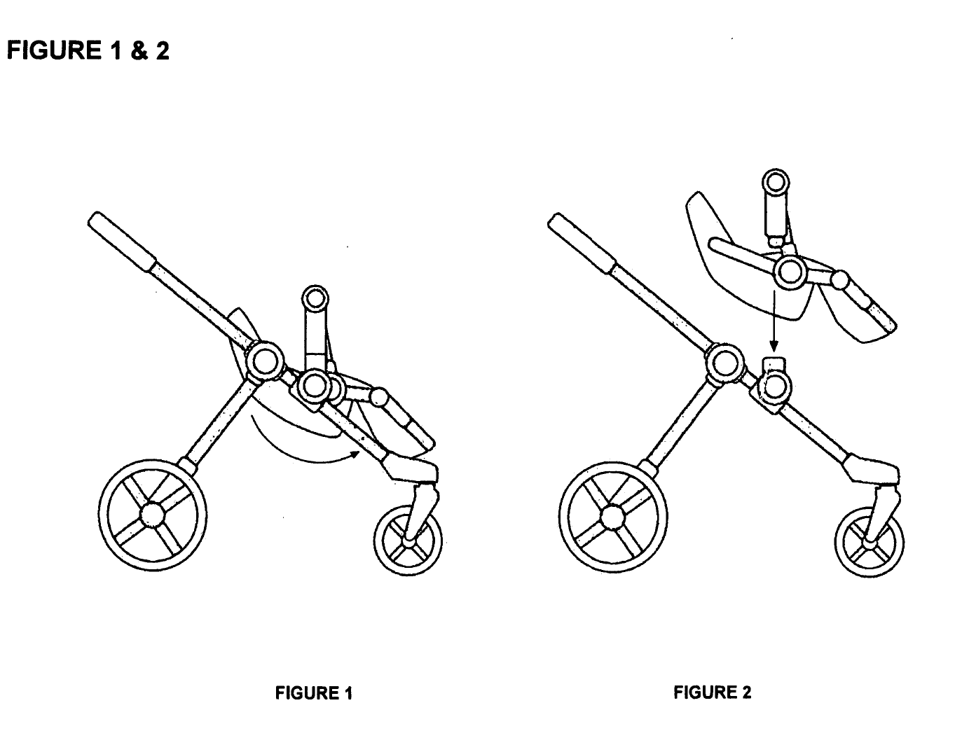

This invention, accordingly, comprises of a two way operation; one of which, is a manual operation via a lever situated on the handle of the stroller, it can also trigger the swing system to allow the swing system to turn on and swing by itself when the stroller is in motion, the lever mechanically connects to the rotary connector of the swing system through steel cables running down through tubing within the frame of a stroller, it relates more particularly to a swing system with a release function, as shown in FIG. 1. It pivots from each sides of a stroller near the seat, which acts as a release frame also, a release frame and a detachable swing seat in one, as illustrated in FIG. 1.

The swing gently swings forward and back up-to 100 degrees, with respect to the release frame to soothe the infant/child, said release frame can also be taken out as and when it is necessary, see FIG. 5. The release mechanism can also be switched off, so as to leave the seat on a stationery mode. It has a safety method that it does not hinder the childs safety at any point, whilst the infant/child is seated, it will therefore be safely placed away from the child arms reach. At any time, while the swing is in motion, a release button may be used to stop the swing system, this is the release frame which pivots the swing system of the seat.

The release frame; FIG. 1., acts as the only operator, or a two way operator, with the option of it being controlled via the lever on the handle FIG. 3. The release frame can work by itself for the swing operation for the seat of a stroller, once it is turned on to swing, it can swing by itself with the help of the movement of the stroller by the jerking or pushing and pulling of the stroller forward and back to lull/soothe and or entertain the child seated.

FIG. 4. relates to the said swing system which can also be controlled via the pushing of the seat, up and down, to allow the seat to start swinging, this is the same principle used on a playground swing. FIG. 3 shows how the swing system can also be controlled to support the swing system, so it can leave the parent a more greater control on when to allow the triggering of the swing system. FIG. 1 relates to the swing systems mechanical elements within the frame which also triggers the swing system when controlled by the lever on the handle as shown in FIG. 3. the mechanical elements are a steel tubing run down through the stroller frame from each side so as to reach the swing connectors—FIG. 1, till it reaches the release mechanism FIG. 2 for the swing to engage for movement.

Drawing: the invention comprises a release system for the seat of a stroller, said release mechanism being located on either sides of the seat FIG. 2 to allow the swinging seat FIG. 4 to gently move forward and back, to provide entertainment to the infant occupied during a journey. The release frame FIG. 5 acts to pivot the swing system, is safely located away from the child's reach. There is a manually operated lever FIG. 3 which releases the seat whenever the swinging motion is desired to be used. The seat and release frame can also be detached from the stroller if required.

1. A stroller swing system can be manually operated using a lever on the handle of the stroller which
operates via a steel tubing run down through the frame till it reaches the release mechanism as shown in
drawing 1 FIG. 1. The swing system is invented for the purpose of entertainment to the child.

2. A stroller swing system which can be manually operated using pivoted release frames which is triggered
via the motion of the stroller when it is in its in use position, shown on drawing 1 FIG. 4. The release
frame has a switch on button with the option to have the reclining control amalgamated. The swing defined
in claim 1 can also be released via the lever placed on the handle of the stroller as shown on drawing 1.

3. A stroller swing system can be operated via the movement of the stroller by a way of force (when it is
pushed at the handle at the journey) to release the functionality of the swing, via the release frame's/part's
on either side of the seat drawing 1 FIG. 4.

4. A stroller swing system can be operated via a force of a push using the same principle as the playground
swing so as to mimic the motion forward and back up-to 100 degrees, see drawing 2 FIG. 1.

5. A stroller swing system that can be detachable from its release functions/frames which works to pivot the
swing forward and back, see drawing 2 FIG. 2.

6. A stroller swing system release frames that pivot on each side of the seat can also retro fit onto a wide [symbol]
